(19) United States
(12) Patent Application Publication
(10) Pub. No.: US 2024/0308376 A1
(43) Pub. Date: Sep. 19, 2024

(54) HIGH THROUGHPUT CHARGING OF FAST CHARGING ELECTRICAL VEHICLES

(71) Applicant: STOREDOT LTD., Herzeliya (IL)

(72) Inventors: Daniel ARONOV, Netanya (IL); Doron Myersdorf, Herzeliya, (IL)

(73) Assignee: STOREDOT LTD., Herzeliya (IL)

(21) Appl. No.: 18/314,109

(22) Filed: May 8, 2023

Related U.S. Application Data
(60) Provisional application No. 63/490,117, filed on Mar. 14, 2023.

(51) Int. Cl. B60L 53/62; B60L 58/12; B60L 58/18

(52) U.S. Cl. CPC B60L 53/62; B60L 58/12; B60L 58/18; B60L 2260/40

(57) ABSTRACT

A method for high-throughput charging of fast charging electrical vehicles (FCEVs), the method may include: (a) obtaining information about optimal charging patterns (CP) of a set of FCEVs that exhibit a charging rate that exceeds two C; (b) determining a set of actual CPs for charging the set of the FCEVs in an at least partially overlapping manner, wherein an actual CP of a given FCEV of the set of the FCEVs is a residual CP that (i) is determined based on a CP of another FCEV of the set of FCEVs, and (ii) significantly differs from an optimal CP of the given FCEV; wherein the CP of the other FCEV is selected out of an optimal CP of the other FCEV and an actual CP of the other FCEV; and (c) executing at least a part of the charging, by a charging system, of the set of the FCEVs in the at least partially overlapping manner.

### CROSS REFERENCE

This application claims priority from U.S. provisional patent application Ser. No. 63/490,117, Mar. 14, 2023, that is incorporated herein by reference BACKGROUND

A fast charging electrical vehicle (EV) is an electrical vehicle that can be charged at a Crate that exceeds 2 and may range between 4-10 C, 5-50 C, and the like.

Each fast charging EV has an optimal charging pattern—that is tailored to the battery of the fast charging EV. Examples of optimal charging patterns are illustrated in the P3 charging index report of July 2022. In general, the evaluated vehicles have an optimal charging pattern that includes (a) a start state of charge (SOC) segment in which the EV battery is relatively empty and the charging rate is high, (b) and intermediate SOC segment in which the charging rate reaches a peak, and (c) an end SOC segment in which the charging rate dramatically decreases. The optimal charging pattern of some vehicles reach the peak relatively early (for example—when the SOC is between 10%-25%—Tesla-Model 3 LR, Mercedes-Benz EQS450+, BMW—14 eDrive40, Hyundai-Kona, Tesla—Model Y LR), and some other vehicle reach the peak relatively late (for example—when the SOC is between 45% and 80%—Porsche—Taycan GTS, Audi—e-Tron GT quattro, Audi e-Tron 55 quattro, KIA EV6, Hyundai—IONIQ 5, Mini-Cooper SE).

The different EVs significantly differ from each other by their average charging power consumption—between less than 100 kW and about 350 kW.

Chargers at charging stations—especially charging stations that are not located at the residences of the drivers of the fast charging EVs—may be required to charge multiple EVs—virtually at once. The charging process is lengthy and a sequential charging of fast charging EVs—one after the other—may require driver to wait for lengthy periods of time.

There is a growing need to speed up the charging process of multiple EVs.

### SUMMARY

There may be provide a system, non-transitory computer readable medium and method for high throughput charging of fast charging electrical vehicles.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates examples of a method;

FIG. 2 illustrates examples of a method;

FIG. 3 illustrates examples of a charging system;

FIG. 4 illustrates examples of one or more charging patterns;

FIG. 5 illustrates examples of one or more charging patterns;

FIG. 6 illustrates examples of one or more charging patterns;

FIG. 7 illustrates examples of one or more charging patterns;

FIG. 8 illustrates examples of one or more charging patterns;

FIG. 9 illustrates examples of one or more charging patterns; and

FIG. 10 illustrates examples of one or more charging patterns.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a charging system capable of executing the method and/or to a non-transitory computer readable medium for implementing the charging.

Any reference in the specification to a charging system should be applied mutatis mutandis to a method for charging by the charging system battery and/or to a non-transitory computer readable medium for implementing the charging.

Any reference in the specification to a non-transitory computer readable medium should be applied mutatis mutandis to a method for charging and/or to a charging system that implementing the charging.

Any combination of any module or unit listed in any of the figures, any part of the specification and/or any claims may be provided.

Any combination of any steps of any method illustrated in the specification and/or drawings may be provided.

Any combination of any subject matter of any of claims may be provided.

There is provided a method and/or a non-transitory computer readable medium and/or a charging system for high throughput charging of fast charging electrical vehicles (FCEVs).

High-throughput may mean a throughput that is obtained by serially charging one FCEV after the other.

The suggested solution may involve charging FCEVs by a charging station by applying actual charging patterns (CPs)—at least one of that actual CPs may significantly differ from at least one or more corresponding optimal CPs of one or more FCEVs. The actual CPs are defined to increase the throughput of the charging station—for example by increasing the parallelism of the charging.

The solution may stop the charging of a FCEV—even when the FCEV is not fully charged at the end of the charging—in order to improve the throughput.

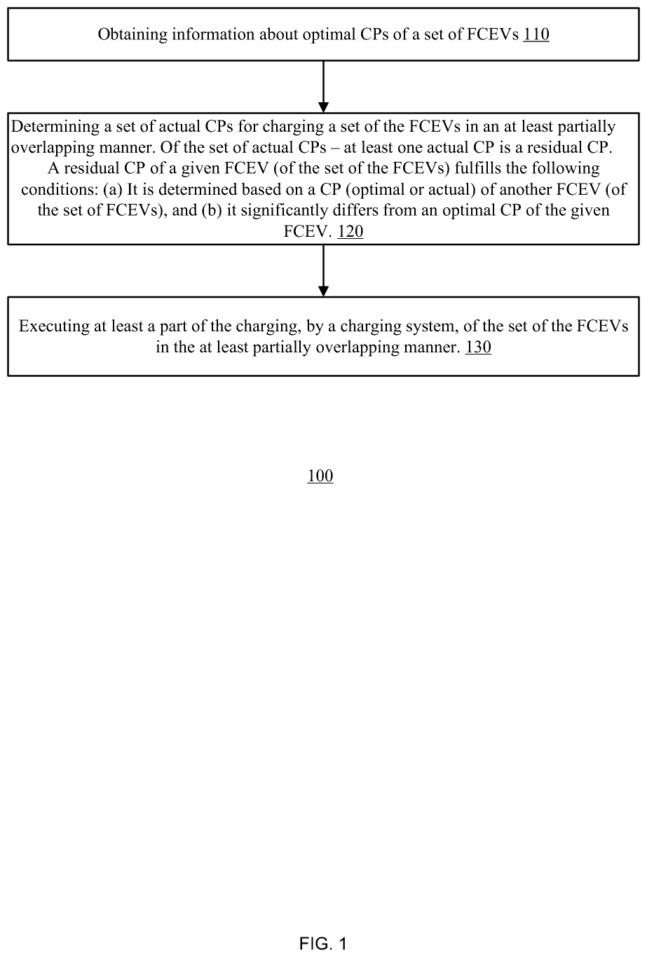

FIG. 1 illustrates an example of a computerized method 100 for high-throughput charging of FCEVs.

Method 100 includes step 110 of obtaining information about optimal CPs of a set of FCEVs. The information may be obtained in one or more manner—for example may be received from manufacturers of the FCEVs, be obtained from various publications regarding the optimal CPs, and the like.

Step 110 is followed by one or more iterations of the next steps (step 120 and/or 130) of method 100.

Step 120 includes determining a set of actual CPs for charging a set of the FCEVs in an at least partially overlapping manner.

A set of FCEVs includes FCEVs that are determined by be charged in an at least partially overlapping manner,

At least partially overlapping manner means that there may be at least a partial overlap between the charging of two or more FCEVs of the set.

Of the set of actual CPs—at least one actual CP is a residual CP.

According to an embodiment—a residual CP of a given FCEV (of the set of the FCEVs) fulfills the following conditions:
a. It is determined based on a CP (optimal or actual) of another FCEV (of the set of FCEVs).
b. It significantly differs from an optimal CP of the given FCEV.

A significant difference between the optimal CP of the given FCEV and the actual CP of the given FCEV may be defined in various manners. For example—a significant difference may fulfill at least one of the following:
a. An average charging rate of a start state-of-charge (SOC) segment of the actual CP of the given FCEV is lower by at least 20% than an average charging rate of a start SOC segment of the optimal CP of the given FCEV.
a. A SOC value of a highest peak of the actual CP of the given FCEV differs by at least 10% from the SOC value of a highest peak of the optimal CP of the given FCEV.
b. A number of local peaks of the actual CP of the given FCEV differs by at least 10% from the number of local peaks of the optimal CP of the given FCEV.
c. A number of local peaks of the actual CP of the given FCEV differs by at least 10% from the number of local peaks of the optimal CP of the given FCEV.
d. A correlation between the actual CP of the given FCEV and an actual CP of a further FCEV of the set of FCEVs is lower than correlation between an optimal CP of the given FCEV and an optimal CP of the further FCEV.

According to one or more embodiments—the residual CP, once applied, does not reach a heating limitation associated with charging the given FCEV.

According to one or more embodiments—the residual CP, once applied does not reach a chemical limitation associated with charging the given FCEV.

According to one or more embodiments—step 120 includes at least one of the following:
a. Determining the set of actual CPs even before charging any of the FCEV.
b. Determining an actual CP of a FCEV after determining an actual CP of another FCEV.
c. Amending an actual CP before a completion of an implementation of the actual CPs.
d. Determining the set of actual CPs by performing one or more optimization process.
e. Determining the set of actual CPs while taking into account constraints related to the entire set of FCEVs.
f. Determining a sub-set of actual CPs while taking into account constraints related only to the sub-set of FCEVs.
g. Determining the set of actual CPs while knowing in advance the set of FCEVs.
h. Determining at least a part of the set of actual CPs without knowing in advance the entire set of FCEVs.
i. Determining the set of actual CPs without knowing in advance a starting time of charging of at least one of the set for FCEVs.
j. Determining the set of actual CPs when knowing in advance a starting time of charging of at least one of the set for FCEVs.
k. Performing the determining in a sequential manner—for example one actual CP after another.
l. Performing the determining in a parallel manner—for example all actual CP at once.
m. Applying an optimization process for optimizing one or more charging parameters associated with the set of FCEVs and with one or more charging parameters associated with the charging system.
n. Performing the determining in an iterative manner.
o. Changing at least one actual CP of at least one FCES of the set of FCEVs during the charging.
p. Determining one actual CP before determining another actual CP.
q. Determining one actual CP before being aware that the other actual CP should be determined.
r. Determining at least one actual CP based on an initial state of at least one of the FCEVs (state may be SOC before starting to charge).
s. Determining at least one actual CP based on a battery and/or FCEV current and/or voltage limits of at least one of the FCEVs.
t. Determining at least one actual CP based on a temperature of at least one battery of at least one of the FCEVs.
u. Determining at least one actual CP based on a loads formed during the charging outside the charging system and the FCEVs.
v. Determining at least one actual CP based on a charging limitations of the charging system.

An example of two greedy algorithms that can be used in step 120 are minimum spanning tree algorithm (Prim, Kruskal) and a shortest path algorithm (Dijkstra).

Both look similar, they focus on two different requirements. In minimum spanning tree, requirement is to reach each vertex once and total cost of reaching each vertex is required to be minimum among all possible combinations.

Dijkstra's—Here the goal is to reach from start to end. You are concerned about only these 2 points and optimize the path accordingly.

Krusal's—Here you can start from any point and must visit all the other points in the graph. So, you may not always choose the shortest path for any two points. Instead, the focus is to choose the path that will lead you to a shorter path for all the other points.

In the current application, the inputs are:
a. Pin—the maximum available charger power;
b. t0(K)—the charging process starting time for each EV;
c. Pmax(K)—the maximum possible charging power for each EV, determined by chemistry, temperature, state of charge, etc;
d. $(K)—the price of charging power (may vary in accordance with daytime and/or power level);

The optimization is performed, using the one of greedy algorithms, for minimal charging time for each EV (tch_min(K)) based on the inputs above.

In the current application, there is a “start” and “finish” time for every activity (charging). Each activity is indexed by a number for reference. There are two activity categories.
a. Considered activity: is the Activity, which is the reference from which the ability to do more than one remaining Activity is analyzed.
b. Remaining activities: activities at one or more indexes ahead of the considered activity.

The total duration gives the cost of performing the activity. That is (finish—start) gives us the durational as the cost of an activity.

Actually, the greedy extent is the number of remaining activities that can be performed in the time of a considered activity.

Step 120 may include:
a. Scan the list of activity costs ($(K)), starting with index 0 as the considered Index.
b. When more activities can be finished by the time, the considered activity finishes, start searching for one or more remaining activities.
c. If there are no more remaining activities, the current remaining activity becomes the next considered activity. Repeat step a and step b, with the new considered activity. If there are no remaining activities left, go to step d.
d. Return the union of considered indices. These are the activity indices that will be used to maximize throughput.

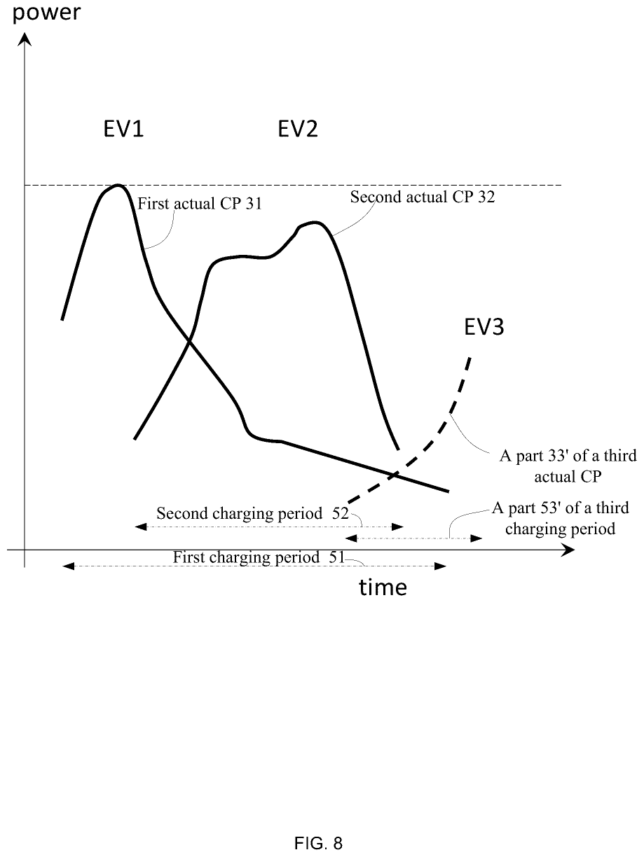

FIG. 8 is an example of charging by optimizing the overall power outputted by the charging system. In FIG. 8 EV1 is prioritized over EV2 and EV3—as can seen by allocating most power to EV1 at the start of the first charging period. EV2 is also prioritized over EV3—as it received more power than EV3 at the beginning of the second charging period. It should be noted that while EV1 may be fully charged when existing the charging station—the charging station may determine to stop charging EV1 before EV1 is fully charged (for example at point 31-2 in which EV1 is charged for at least a predefined amount—for example complete about 80% of the SoC)—and in this case more power can be allocated to EV2 and/or EV3 following the stopping of the charging of EV1.

According to one or more embodiments—step 120 is followed by step 130 of executing at least a part of the charging, by a charging system, of the set of the FCEVs in the at least partially overlapping manner.

According to one or more embodiments—step 130 includes at least one of:
a. Sending instructions and/or requests for executing the charging.
b. Controlling the charging.
c. Performing the charging.

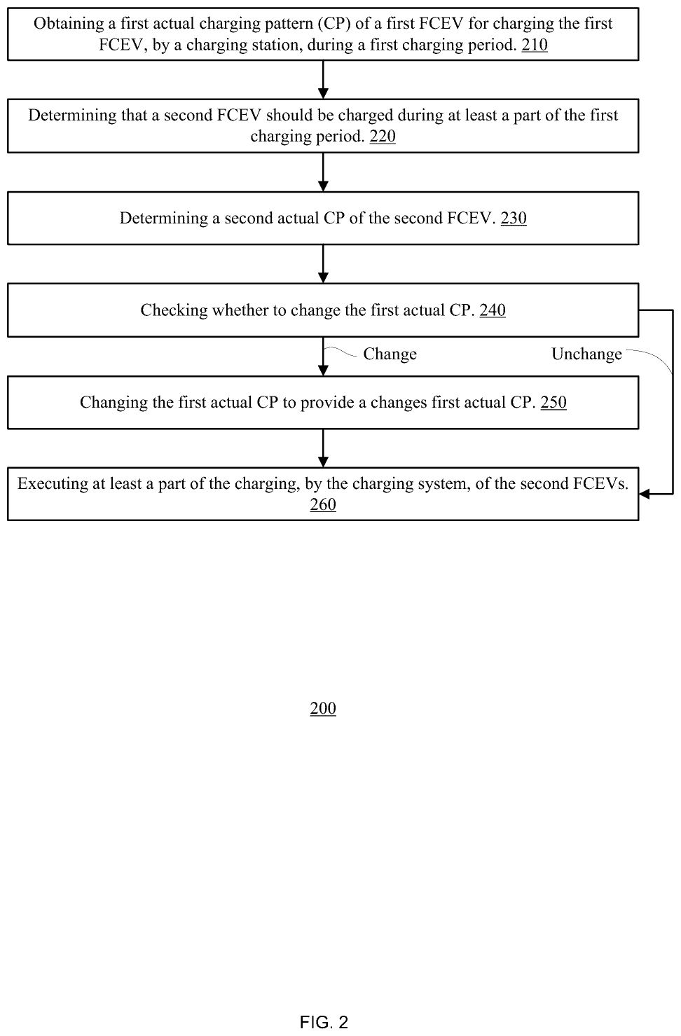

FIG. 2 illustrates an example of a computerized method 200 for high-throughput of FCEVs.

According to one or more embodiments—method 200 starts by step 210 of obtaining a first actual charging pattern (CP) of a first FCEV for charging the first FCEV, by a charging station, during a first charging period.

According to one or more embodiments the obtaining includes receiving the first actual CP or determining the first actual CP.

According to one or more embodiments—step 210 is followed by step 220 of determining that a second FCEV should be charged during at least a part of the first charging period.

According to one or more embodiments—step 220 is triggered by an arrival of the second FCEV to the charging station, by receiving an indication that the second FCEV should be charged by the charging station, and the like.

According to one or more embodiments step 220 is followed by step 230 of determining a second actual CP of the second FCEV.

According to one or more embodiments step 220 is followed by step 240 of checking whether to change the first actual CP.

According to one or more embodiments—step 240 is followed by step 250 of changing the first actual CP to provide a changes first actual CP, when it is determined to change the first actual CP.

If is determined not to change the first actual CP—the first actual CP maintains unchanged.

According to one or more embodiments—the second actual CP and/or the changed first actual CP is a residual CP.

For example—the changed first CP may be determined based on the second actual CP and may significantly differ from the first optimal CP.

Yet for another example—the second actual CP may be determined based on the first actual CP and may significantly differ from the second optimal CP.

Yet for a further example—the first CP may be determined based on an actual CP of another FCEV—and may significantly differ from the first optimal CP.

According to one or more embodiments—at least one steps 230, 340 or 250 is followed by step 260 of executing at least a part of the charging, by the charging system, of the second FCEVs.

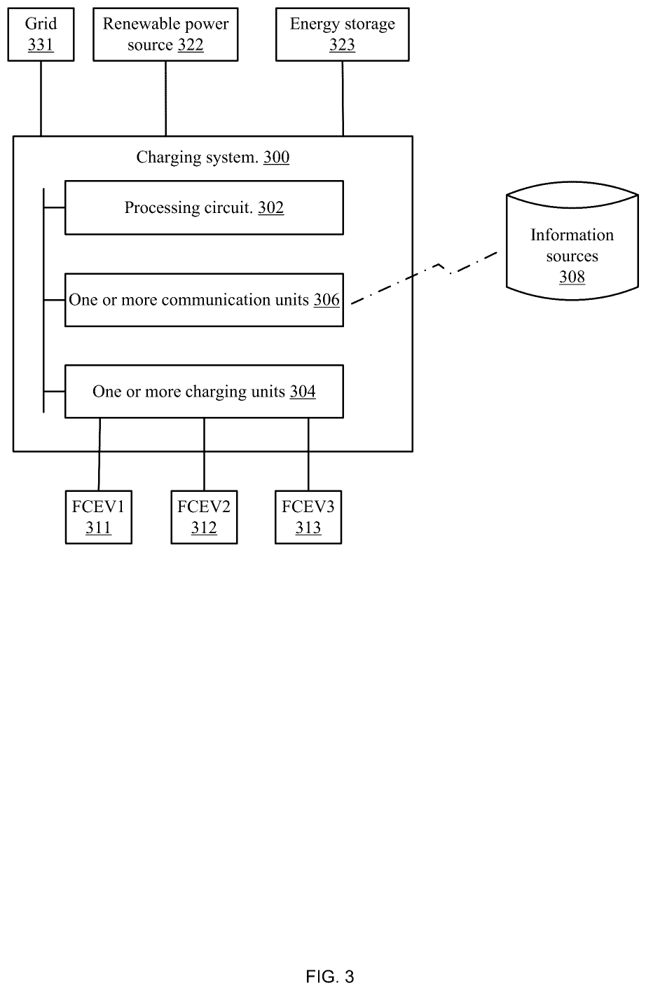

FIG. 3 illustrates an example of a charging system 300.

The charging system 300 may include a processing circuit 302 configured to control the charging station, one or more charging units—collectively denoted 304 for charging FCEVs—such as first FCEV 311, second FCEV 312 and third FCEV 313, one or more communication units 306 for communicating with the FCEVs and/or information sources 308 (such as databases or other information sources)—for obtaining information about the FCEVs—for example obtaining information regarding optimal CPs of the FCEVs.

The charging system 300 and especially the processing circuit 302 is configured to execute at least part method 100 and/or method 200. The charging system may be fed by one or more power sources such as a power grid 331, a renewable power source 322 or an energy storage 323.

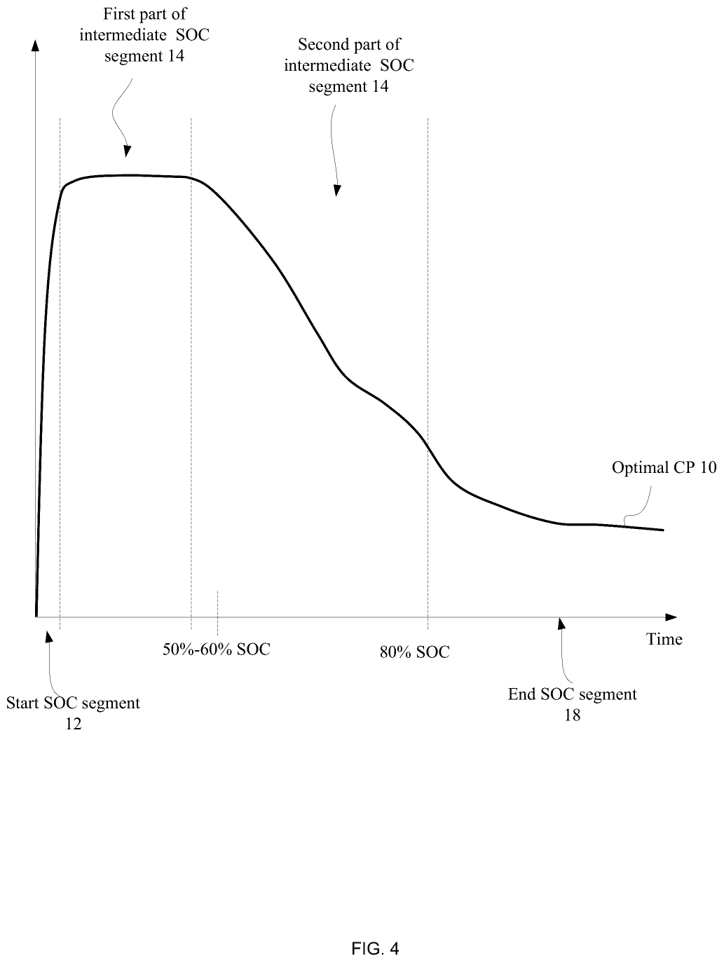

FIG. 4 illustrates an example of optimal CP 10—that includes a start SOC segment 12 followed by a first part of intermediate SOC segment 14, second part of intermediate SOC segment 16 and end SOC segment 18. The average charging rate within the start SOC segment 12 is the fastest—in comparison to all other segments. The power supplied during the first part of intermediate SOC segment 14 is the highest power out of all other segments, whereas the power is limited by the charging system and/or the chemistry limitation of the battery of the FCEV. Cooling limitations of the battery of the FCEV reduce the charging rate during the second part of intermediate SOC segment 16. Chemistry limitations of the battery of the FCEV reduce the charging rate during the end SOC segment 18. The end SOC segment of FIG. 4 starts at 80% SOC, while the second part of the intermediate SOC segment 16 starts before reaching 50%-60% of the SOC.

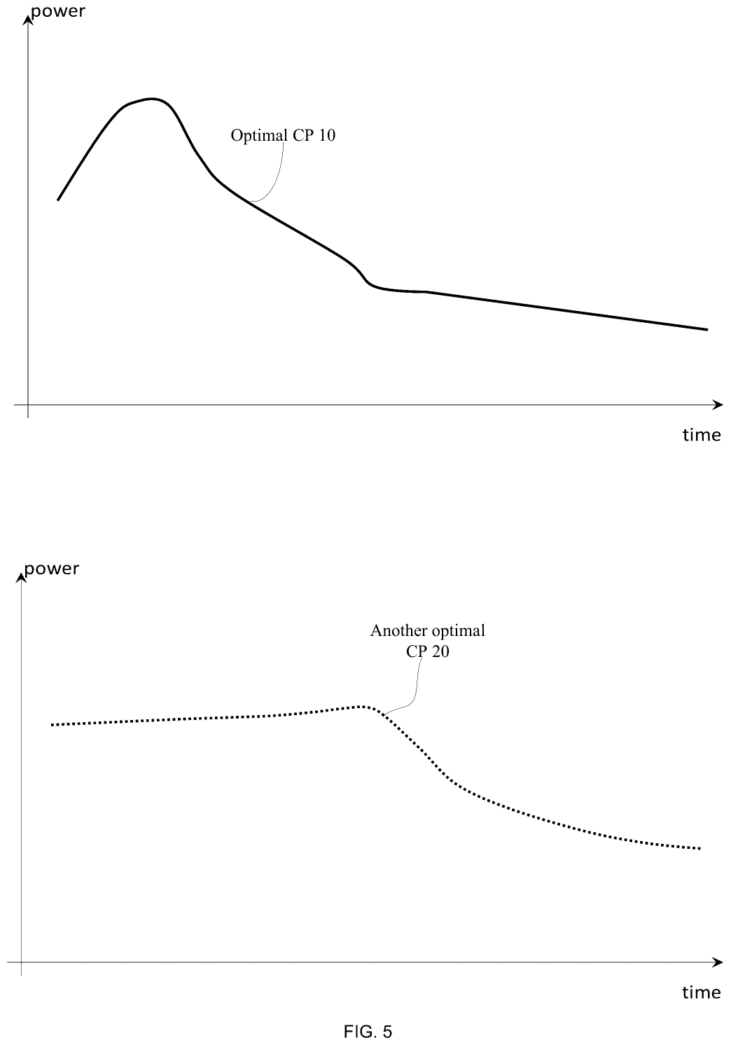

FIG. 5 illustrates an example of optimal CP 10 and an example of another optimal CP 20. The other optimal CP 20 reaches its peak after (in terms of SOC) the peak of the optimal CP 10—and by using a lower charging rate.

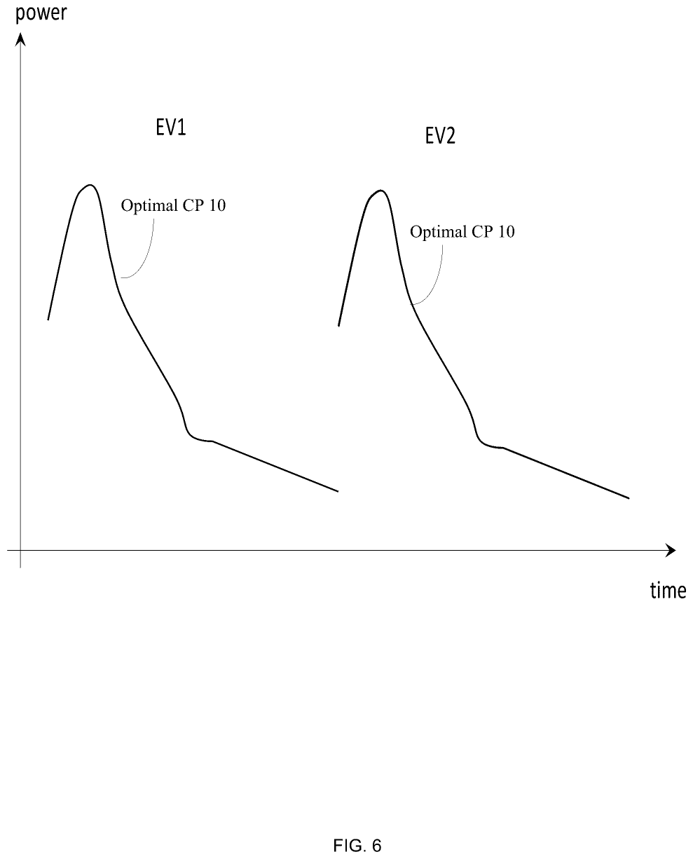

FIG. 6 illustrates an example of charging a first FCEV and a second FCEV at a sequential manner—by applying the optimal CP 10.

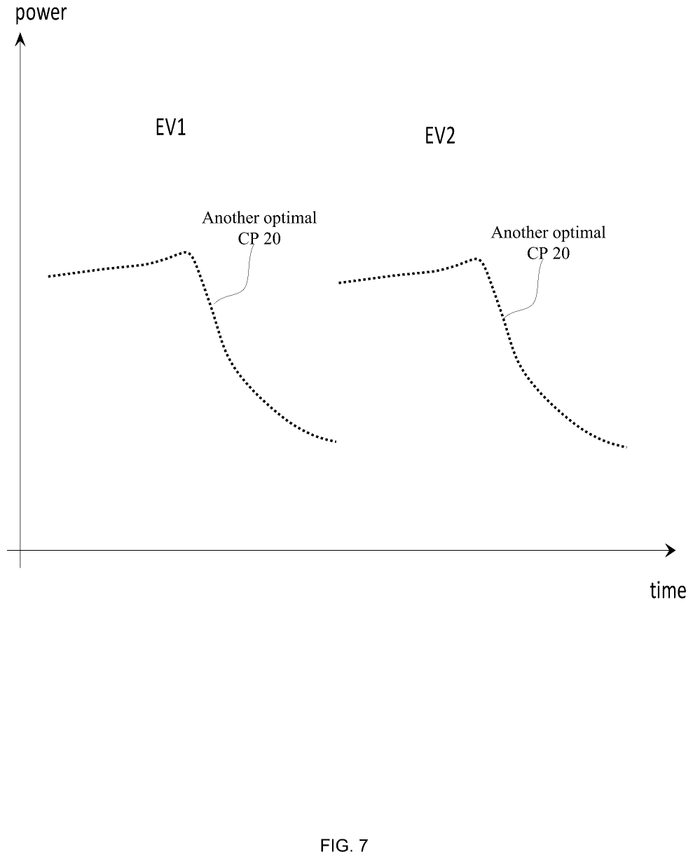

FIG. 7 illustrates an example of charging a first FCEV and a second FCEV at a sequential manner—by applying the other optimal CP 20.

FIG. 8 illustrates an example of charging a first FCEV, a second FCEV and a third FCEV—by applying a first actual CP 31, a second actual CP 32 and the third actual CP 33, respectively. FIG. 8 illustrates only a part 33′ of a third actual CP 33.

The first actual CP 31 equals optimal CP 10. The second actual CP 32 is a residual CP that is determined based on the optimal CP 10 (of the second FCEV) and on the first actual CP 31. The second actual CP 32 significantly differs from the optimal CP 10 of the second FCEV. The third actual CP 33 is determined based on the first actual CP, the second actual CP 31 and the part’ 33 of the third actual CP 33 shown in FIG. 8 significantly differs from the corresponding part of optimal CP 10 of the third FCEV.

FIG. 8 also illustrates (i) a first charging period 51 (of first FCEV), a second charging period 52 (of second FCEV), and a part 53′ of a third charging period (of third FCEV). There are partial overlaps between the first charging period 51, the second charging period 52, and the part 53′ of a third charging period.

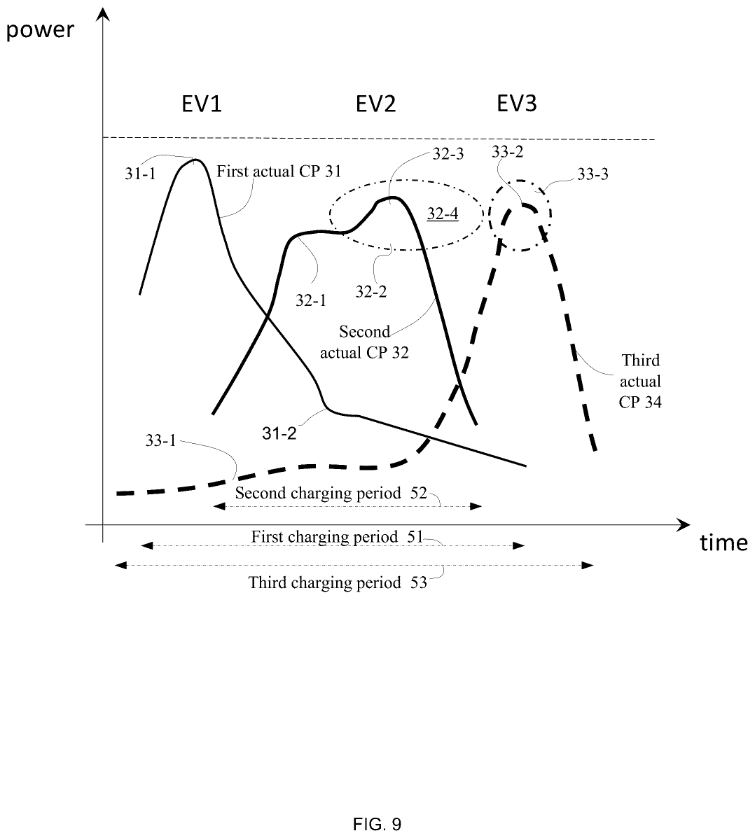

FIG. 9 illustrates an example of charging a first FCEV, a second FCEV and a third FCEV—by applying a first actual CP 31, a second actual CP 32 and the third actual CP 34, respectively. The third actual CP 34 of FIG. 9 differs from the third actual CP (of which only a part was shown) of FIG. 8.

Assuming that the optimal CP of the three FCEVs equals the first actual CP 31—FIG. 9 illustrates differences in the actual CPs of the second FCEV and the third FCEV—and their optimal CPs.

The first actual CP 31 (initially equals optimal CP) has a single peak 31-1 located at a first SOC value. The second actual CP 32 has a first local peak 32-1 followed by second peak 32-3, whereas the second peak is located at a second SOC value that exceeds the first SOC value. The second peak 32-3 defines an additional charging region. The CP of many Li ion batteries include re reduction of the charging following the first peak. CP 2 represents an improved Li ion battery that can be charged faster—due to the presence of the additional charging region. The additional charging region also ends at an end point that is higher than the point of a Li battery without the additional charging region—that also increases the charging after the additional charging region. The third actual CP 34 has a peak 33-2 that is located at a third SOC value—way beyond the first SOC value of peak 31-1. The average charging rate at the start SOC segment of the third actual CP 33 is a fraction (for example below 25% of the average charging rate at the start SOC segment of the optimal CP 10).

The shape of the first actual CP 31 significantly differs from the shape of the second actual CP 32 and 31 significantly differs from the shape of the third actual CP 33.

Referring to method 100—and under the assumption that the first actual CP equals an optimal CP, at least one of the following is true:
a. The first actual CP was determined regardless the second actual CP and/or the second optimal CP.
b. The first actual CP was determined regardless the third actual CP and/or the third optimal CP.
c. The first actual CP was determined based on the second actual CP and/or the second optimal CP.
d. The first actual CP was determined based on the third actual CP and/or the third optimal CP.
e. The second actual CP was determined regardless the first actual CP and/or the first optimal CP.
f. The second actual CP was determined regardless the third actual CP and/or the third optimal CP.
g. The second actual CP was determined based on the first actual CP and/or the first optimal CP.
h. The second actual CP was determined based on the third actual CP and/or the third optimal CP.

It has been found that when large currents are applied, the lithium plating rate can be much faster than the transport rate so that a huge concentration gradient forms at the growth front of lithium. In extreme cases, Lithium ions would be depleted at the anode surface and even drop to zero. This is situation even worse at high state of charge regions. Lithium deposits tend to propagate into the receding cation-available regions and form diffusion-limited apical-growing dendrites. Thus, for a standard lithium ion cell with graphite based anode, applying a high charging current at high state of charge is unacceptable, and may result in safety issue.

However, an improved Li ion batteries that include silicon dominant anodes, with as at least 30% silicon by weight, inherently have lower probability of dendrite nucleation and growth due to faster kinetics of alloying reaction than traditional graphite based anodes. Improved ion batteries may be obtained using optimizing cell design and silicon dominant anode structure, which is capable for the extreme fast charging in a wide range of state of charge.

Examples of improved Li ion batteries are illustrated in U.S. provisional patent application Ser. No. 63/490,117 that is incorporated herein by reference.

The improved Li ion battery may include, instead of a conventional graphite anode, silicon-based nanoparticles.

The anode can include dispersing nanosized silicon particle in a unique conductive organic and inorganic matrix to accommodate the silicon volumetric changes and maintain overall mechanical integrity. Examples of such anodes are illustrated in U.S. provisional patent application Ser. No. 63/490,117 that is incorporated herein by reference In addition, an electrolyte, including several organic additives synthesized in-house, stabilizes the cell system over many charge and discharge cycles. Examples of the electrolyte and/or of organic additives are illustrated in U.S. provisional patent application Ser. No. 63/490,117 that is incorporated herein by reference. Those additives provide advantages including better safety, thermal stability and long cycle life.

Combining these elements of silicon-based anode in conjugation with highly conductive cathode, improved thermal efficiency, optimized ratio between electrodes, and customized electrolyte enable high energy density while delivering extremely high rate of lithium insertion. Examples of such combinations and/or optimized ratios are illustrated in U.S. provisional patent application Ser. No. 63/490,117 that is incorporated herein by reference. This mechanism demonstrates sufficiently low probability of risk of lithium dendrites and better overall safety of XFC.

The improved Li ion battery can be manufactured using a holistic view of the materials and the system electrochemistry of the battery cell is critical. The process may integrates chemistry and engineering sciences, while applying a layer of artificial intelligence and machine learning to optimize overall fast charging performance. Examples of the holistic view and/or of the artificial intelligence and/or machine learning are illustrated in U.S. provisional patent application Ser. No. 63/490,117 that is incorporated herein by reference. The resulting technology can be implemented in three types of cells—cylinder, prismatic, and pouch—all in various sizes and capacities, depending of the vehicle's battery pack configuration. Examples of resulting technology and/or of implementations in various types of cells are illustrated in U.S. provisional patent application Ser. No. 63/490,117 that is incorporated herein by reference.

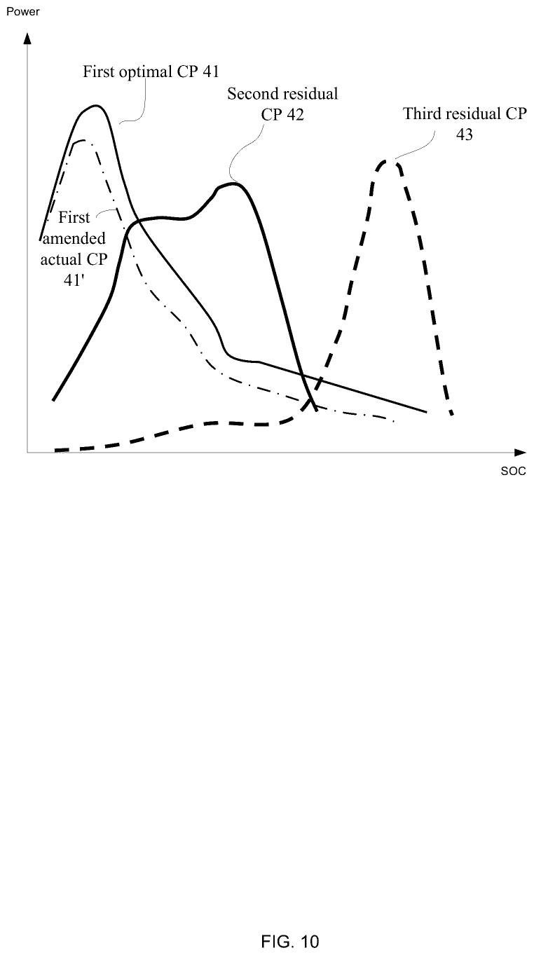

FIG. 10 illustrates an example of a comparison between the first actual CP 41, the second actual CP 42 and the third actual CP 43′.

FIG. 10 also illustrates that the first actual CP 31 was amended to provide first amended actual CP 41′.

In general, given a set of K FCEVs to be charged in a partially overlapping manner, K being an integer that exceeds one.
a. According to one or more embodiments, the entire K actual CPs is calculated by a process that takes into account all K FCEVs.
b. According to one or more embodiments—a subset of the K actual CPs is calculated by a process that takes into account only FCEVs of the subset.
c. According to one or more embodiments—a subset of the K actual CPs is calculated by a process that takes into account only some (but not all) of the K FCEVs.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first”, “second”, “third” and “fourth” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for high-throughput charging of fast charging electrical vehicles (FCEVs), the method comprises:
obtaining information about optimal charging patterns (CP) of a set of FCEVs that exhibit a charging rate that exceeds two C;
determining a set of actual CPs for charging the set of the FCEVs in an at least partially overlapping manner, wherein an actual CP of a given FCEV of the set of the FCEVs is a residual CP that (i) is determined based on a CP of another FCEV of the set of FCEVs, and (ii) significantly differs from an optimal CP of the given FCEV; wherein the CP of the other FCEV is selected out of an optimal CP of the other FCEV and an actual CP of the other FCEV; and
executing at least a part of the charging, by a charging system, of the set of the FCEVs in the at least partially overlapping manner.

2. The method according to claim 1, wherein an average charging rate of a start state of charge (SOC) segment of the actual CP of the given FCEV is lower by at least 20% than an average charging rate of a start SOC segment of the optimal CP of the given FCEV.

3. The method according to claim 1, wherein a state of charge (SOC) value of a highest peak of the actual CP of the given FCEV differs by at least 10% from the SOC value of a highest peak of the optimal CP of the given FCEV.

4. The method according to claim 1, wherein a number of local peaks of the actual CP of the given FCEV differs by at least 10% from the number of local peaks of the optimal CP of the given FCEV.

5. The method according to claim 1, wherein a number of local peaks of the actual CP of the given FCEV differs by at least 10% from the number of local peaks of the optimal CP of the given FCEV.

6. The method according to claim 1, wherein a correlation between the actual CP of the given FCEV and an actual CP of a further FCEV of the set of FCEVs is lower than correlation between an optimal CP of the given FCEV and an optimal CP of the further FCEV.

7. The method according to claim 1, wherein at least two actual CPs of at least two FCEVs of the set of the FCEVs are residual CPs, the at least two FCEVs comprise the given FCEV.

8. The method according to claim 1, wherein the residual CP, once applied does not reach a heating limitation associated with charging the given FCEV.

9. The method according to claim 1, wherein the residual CP, once applied does not reach a chemical limitation associated with charging the given FCEV.

10. The method according to claim 1, wherein the determining of the set of actual CPs for charging the set of the FCEVs comprises applying an optimization process for optimizing one or more charging parameters associated with the set of FCEVs and with one or more charging parameters associated with the charging system.

11. The method according to claim 1, wherein the determining of the set of actual CPs is based on timing information regarding a beginning of a charging of the FCEVs of the set of FCEVs.

12. The method according to claim 1, wherein the determining comprises changing at least one actual CP of at least one FCES of the set of FCEVs during the charging.

13. The method according to claim 1, wherein the determining of the set of actual CPs for charging the set of the FCEVs comprises determining one actual CP before determining another actual CP.

14. The method according to claim 13, wherein the determining of the set of actual CPs for charging the set of the FCEVs comprises determining one actual CP before being aware that the other actual CP should be determined.

15. The method according to claim 1 wherein at least one of the FCEVs has anode that includes at least 30% silicon by weight.

16. A non-transitory computer readable medium for high-throughput charging of fast charging electrical vehicles (FCEVs), the non-transitory computer readable medium stores instructions that once executed by a processing circuit, causes the processing circuit to:
obtain information about optimal charging patterns (CP) of a set of FCEVs that exhibit a charging rate that exceeds two C;
determine a set of actual CPs for charging the set of the FCEVs in an at least partially overlapping manner, wherein an actual CP of a given FCEV of the set of the FCEVs is a residual CP that (i) is determined based on a CP of another FCEV of the set of FCEVs, and (ii) significantly differs from an optimal CP of the given FCEV; wherein the CP of the other FCEV is selected out of an optimal CP of the other FCEV and an actual CP of the other FCEV; and
execute at least a part of the charging, by a charging system, of the set of the FCEVs in the at least partially overlapping manner.

17. A method for high-throughput charging of fast charging electrical vehicles (FCEVs), the method comprises:
obtaining a first actual charging pattern (CP) of a first FCEV for charging the first FCEV, by a charging station, during a first charging period;
determining that a second FCEV should be charged during at least a part of the first charging period;
determining a second actual CP of the second FCEV;
checking whether to change the first actual CP;
changing the first actual CP to provide a changes first actual CP, when it is determined to change the first actual CP; and
executing at least a part of the charging, by the charging system, of the second FCEVs;
wherein at least one of the second actual CP and the changed first actual CP is a residual CP; wherein a residual CP of a given FCEV is determined based on a CP of another FCEV, and (ii) significantly differs from an optimal CP of the given FCEV; wherein the CP of the other FCEV is selected out of an optimal CP of the other FCEV and an actual CP of the other FCEV.
